(19) United States
(12) Patent Application Publication
(10) Pub. No.: US 2024/0076224 A1
(43) Pub. Date: Mar. 7, 2024

(54) MOLDING METHOD FOR COVER WINDOW

(71) Applicants: Samsung Display Co., LTD., Yongin-si (KR); InnoWorks, Daejeon (KR)

(72) Inventors: HYUNSEUNG SEO, Yongin-si (KR); Young Ki PARK, Daejeon (KR); Jong Soo BAEK, Daejeon (KR); JIHYUN KO, Yongin-si (KR); SEUNGHO KIM, Yongin-si (KR); Jin Su NAM, Yongin-si (KR); Oh Joo PARK, Daejeon (KR); JUN HO LEE, Yongin-si (KR)

(21) Appl. No.: 18/456,432

(22) Filed: Aug. 25, 2023

(30) Foreign Application Priority Data
Sep. 7, 2022 (KR) 10-2022-0113820

(51) Int. Cl. C03B 23/03

(52) U.S. Cl. CPC C03B 23/0307; C03B 23/0302; C03B 23/0305; C03B 2215/44

(57) ABSTRACT

A molding method for a cover window includes: locally heating a peripheral portion of a glass substrate around a central portion of the glass substrate to a temperature of about 610° C. to about 670° C., forming a cover window by pressing the glass substrate, and annealing and cooling the cover window. Accordingly, a cover window in which each of edges has an outwardly convex curved surface through a glass substrate may be formed. In addition, the surface roughness of a cover window formed through a glass substrate may be improved.

### CROSS-REFERENCE TO RELATED APPLICATION

This application claims priority to and the benefit of Korean Patent Application No. 10-2022-0113820, filed on Sep. 7, 2022 in the Korean Intellectual Property Office, the entire content of which is hereby incorporated by reference.

### BACKGROUND

### 1. Field

Aspects of embodiments of the present disclosure relate to a molding method for a cover window.

### 2. Description of the Related Art

As information technology develops, the importance of display devices, which are communication media between users and information, is being highlighted. Accordingly, the use of display devices, such as a liquid crystal display device, an organic light emitting display device, a plasma display device, and the like, is increasing.

The display device may include a cover window protecting a display panel of the display device. For example, in a mobile display device, left and right edges of the cover window may be treated as curved surfaces to be used as a new display surface.

### SUMMARY

According to an aspect of embodiments of the present disclosure, a molding method for a cover window for a display device is provided.

According to one or more embodiments of the present disclosure, a molding method for a cover window includes locally heating a peripheral portion of a glass substrate around a central portion of the glass substrate to a temperature of about 610° C. to about 670° C., forming a cover window by pressing the glass substrate, and annealing and cooling the cover window.

In an embodiment, in the locally heating the glass substrate, an induction coil may be used.

In an embodiment, the forming the cover window may include a first pressing step in which a load applied to the glass substrate gradually increases, a second pressing step in which a load applied to the glass substrate gradually increases, and a third pressing step in which a load applied to the glass substrate is constant.

In an embodiment, a rate at which the load applied to the glass substrate increases in the second pressing step may be different from a rate at which the load applied to the glass substrate increases in the first pressing step.

In an embodiment, a rate at which the load applied to the glass substrate increases in the second pressing step may be greater than a rate at which the load applied to the glass substrate increases in the first pressing step.

In an embodiment, the locally heating the glass substrate may be performed at least partially concurrently with the pressing the glass substrate.

In an embodiment, the cover window may include a flat portion corresponding to the central portion, side portions each adjacent to an edge of the flat portion and including an outwardly convex curved surface, and corner portions each connecting two adjacent side portions among the side portions and including an outwardly convex curved surface.

In an embodiment, a height from an outer surface of the cover window to a virtual plane formed by lower surfaces of the corner portions may be about 3.85 mm to about 4.15 mm.

In an embodiment, a radius of curvature of an inner surface of each of the side portions of the cover window may be equal to a radius of curvature of an inner surface of each of the corner portions of the cover window.

In an embodiment, a planar shape of the peripheral portion of the glass substrate may include a short side extending in a first direction, a long side extending in a second direction orthogonal to the first direction, and a curve connecting an end of the short side and an end of the long side. A width in the second direction between a virtual first line extending from the end of the short side in the first direction and a virtual second line extending from a center of the curve in the first direction may be about 0.5 to about 0.6 of the radius of curvature of the inner surface of each of the corner portions of the cover window.

According to one or more embodiments of the present disclosure, a molding method for a cover window includes locally heating a peripheral portion of a glass substrate around a central portion of the glass substrate, forming a cover window by pressing the glass substrate with a load of about 200 kgf to about 350 kgf, and annealing and cooling the cover window.

In an embodiment, in the locally heating the glass substrate, an induction coil may be used.

In an embodiment, the forming the cover window may include a first pressing step in which a load applied to the glass substrate gradually increases, a second pressing step in which a load applied to the glass substrate gradually increases, and a third pressing step in which a load applied to the glass substrate is constant.

In an embodiment, a rate at which the load applied to the glass substrate increases in the second pressing step may be different from a rate at which the load applied to the glass substrate increases in the first pressing step.

In an embodiment, a rate at which the load applied to the glass substrate increases in the second pressing step may be greater than a rate at which the load applied to the glass substrate increases in the first pressing step.

In an embodiment, the locally heating the glass substrate may be performed at least partially concurrently with the pressing the glass substrate.

In an embodiment, the cover window may include a flat portion corresponding to the central portion, side portions each adjacent to an edge of the flat portion and including an outwardly convex curved surface, and corner portions each connecting two adjacent side portions among the side portions and including an outwardly convex curved surface.

In an embodiment, a height from an outer surface of the cover window to a virtual plane formed by lower surfaces of the corner portions may be about 3.85 mm to about 4.15 mm.

In an embodiment, a radius of curvature of an inner surface of each of the side portions of the cover window may be equal to a radius of curvature of an inner surface of each of the corner portions of the cover window.

In an embodiment, a planar shape of the peripheral portion of the glass substrate may include a short side extending in a first direction, a long side extending in a second direction orthogonal to the first direction, and a curve connecting an end of the short side and an end of the long side. A width in the second direction between a virtual first line extending from the end of the short side in the first direction and a virtual second line extending from a center of the curve in the first direction may be about 0.5 to about 0.6 of the radius of curvature of the inner surface of each of the corner portions of the cover window.

According to one or more aspects, a molding method for a cover window according to embodiments of the present disclosure may include locally heating a peripheral portion of a glass substrate surrounding a central portion of the glass substrate, forming a cover window by pressing the glass substrate, and annealing and cooling the cover window. Here, the pressing the glass substrate may include a first pressing step in which a load applied to the glass substrate gradually increases, a second pressing step in which a rate at which a load applied to the glass substrate increases is greater than a rate at which a load applied to the glass substrate increases in the first pressing step, and a third pressing step in which a load applied to the glass substrate is constant. Accordingly, the cover window in which each of edges has an outwardly convex curved surface through the glass substrate may be formed. In addition, the surface roughness of the cover window formed through the glass substrate may be improved.

### BRIEF DESCRIPTION OF THE DRAWINGS

Some illustrative, non-limiting embodiments will be more clearly understood from the following detailed description in conjunction with the accompanying drawings.

FIG. 1 is a perspective view illustrating a display panel and a cover window, according to an embodiment.

FIG. 2 is a plan view illustrating the cover window of FIG. 1.

FIG. 3 is a cross-sectional view of the cover window of FIG. 1 taken along the line I-I′.

FIG. 4 is a cross-sectional view of the cover window of FIG. 1 taken along the line II-II′.

FIG. 5 is a flowchart illustrating a molding method for a cover window according to an embodiment.

FIG. 6 is a view for explaining the molding method for the cover window of FIG. 5.

FIG. 7 is a plan view illustrating a glass substrate.

FIG. 8 is an enlarged plan view of a region of FIG. 7.

FIGS. 9, 10, and 11 are cross-sectional views for explaining some steps of the molding method for the cover window of FIG. 5.

FIG. 12 is a view illustrating a height of the cover window according to a position of the cover window of FIG. 1.

FIGS. 13A and 13B are views respectively illustrating a clean area ratio and a wrinkle length of the cover window according to temperature in the step of heating the glass substrate of FIG. 5.

FIGS. 14A and 14B are views respectively illustrating a clean area ratio and a wrinkle length of the cover window according to a load in the step of pressing the cover window of FIG. 5.

FIG. 15 is a view for explaining surface roughness of a cover window according to a comparative example and an example.

### DETAILED DESCRIPTION

Herein, a molding method for ca over window according to embodiments of the present disclosure will be explained in further detail with reference to the accompanying drawings. The same reference numerals are used for the same components in the drawings, and redundant descriptions of the same components may be omitted.

It is to be understood that although terms such as “first” and “second” may be used herein to describe various components, these components are not limited by these terms, and the terms are used to distinguish one component from another.

As used herein, the singular forms “a,” “an,” and “the” are intended to include the plural forms as well, unless the context clearly indicates otherwise.

It is to be further understood that the terms “comprises” and/or “comprising” used herein specify the presence of stated features or components, but do not preclude the presence or addition of one or more other features or components.

It is to be understood that when a layer, area, or component is referred to as being “formed on” another layer, area, or component, it may be directly or indirectly formed on the other layer, area, or component. That is, for example, one or more intervening layers, areas, or components may be present.

When an embodiment may be implemented differently, a specific process order may be performed differently from the described order. For example, two consecutively described processes may be performed substantially at the same time or performed in an order opposite to the described order.

In embodiments set forth herein, when a layer, area, or component is connected to another layer, area, or component, the layers, areas, or components may be directly connected to each other, and the layers, areas, or components may also be indirectly connected to each other with another layer, area, or component therebetween.

Unless otherwise defined, all terms (including technical and scientific terms) used herein have the same meaning as commonly understood by one of ordinary skill in the art to which example embodiments of the inventive concept belong. It is to be further understood that terms, such as those defined in commonly-used dictionaries, should be interpreted as having a meaning that is consistent with their meaning in the context of the relevant art and will not be interpreted in an idealized or overly formal sense unless expressly so defined herein.

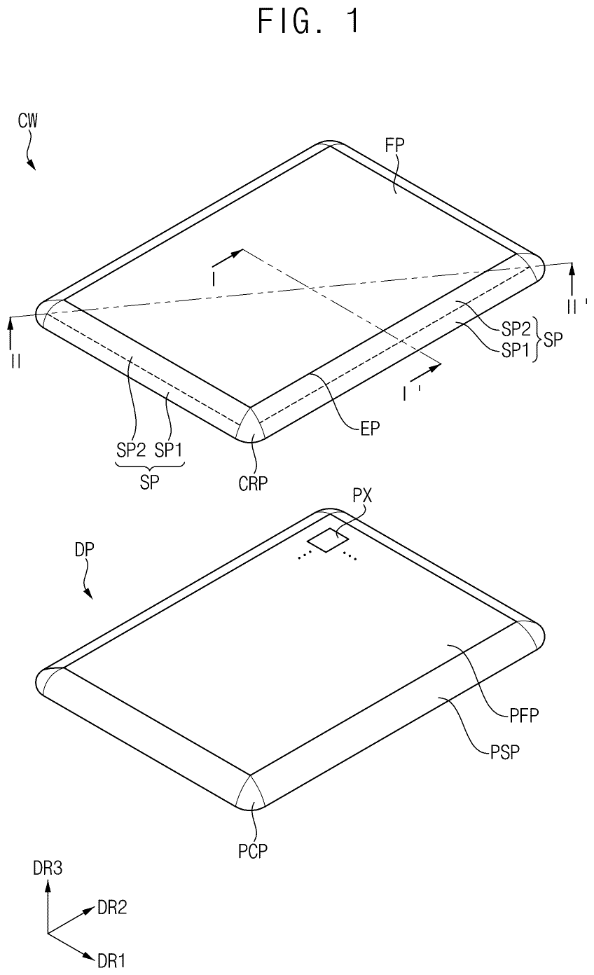

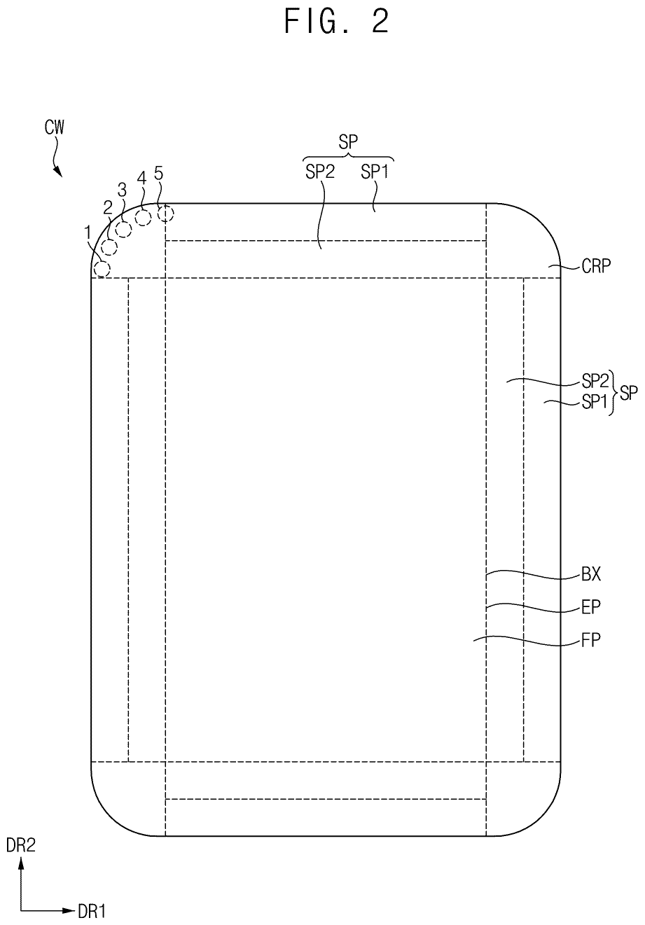

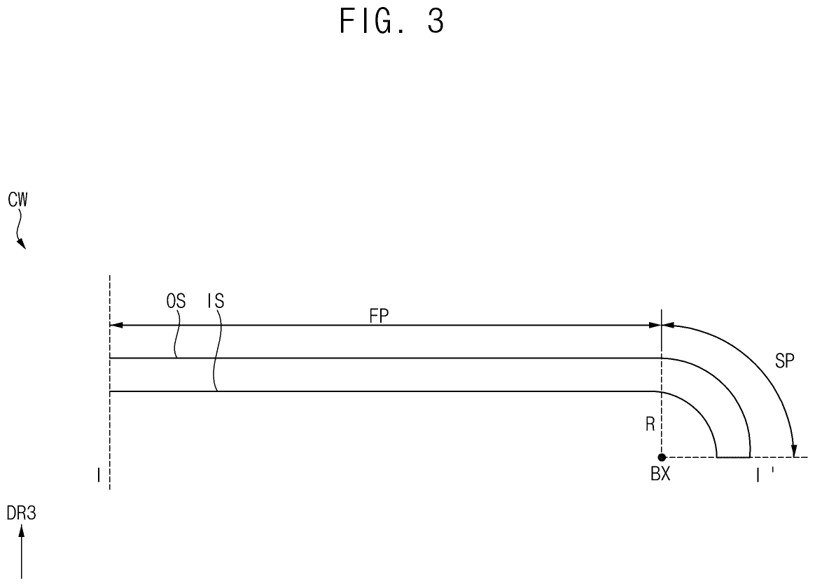

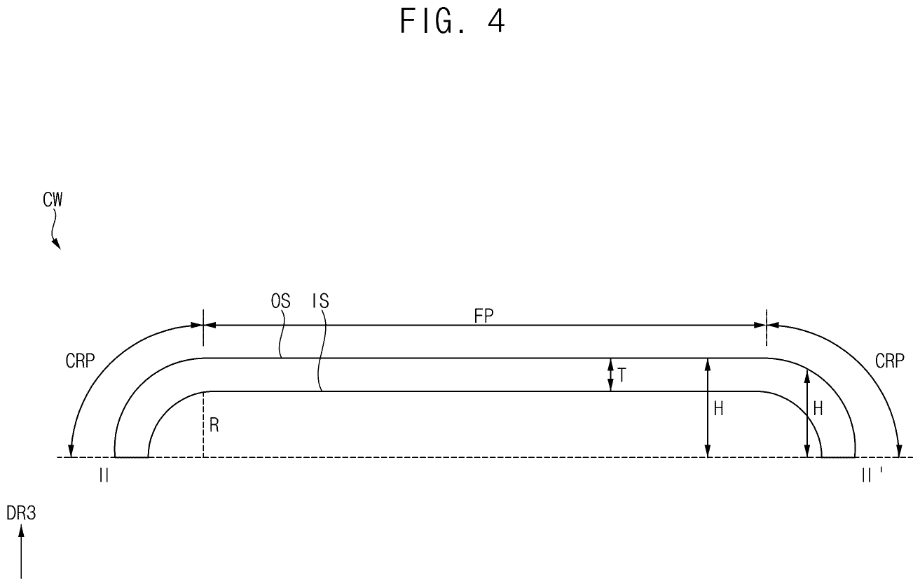

FIG. 1 is a perspective view illustrating a display panel and a cover window, according to an embodiment; FIG. 2 is a plan view illustrating the cover window of FIG. 1; FIG. 3 is a cross-sectional view of the cover window of FIG. 1 taken along the line I-I′; and FIG. 4 is a cross-sectional view of the cover window of FIG. 1 taken along the line II-II′.

Referring to FIGS. 1, 2, 3, and 4, a display device according to an embodiment may include a display panel DP and a cover window CW disposed on the display panel DP.

The display panel DP may be a flexible display panel. For example, the display panel DP may have a curved edge. The display panel DP may be formed to have a curved edge or may have a curved edge by being coupled with the cover window CW or a fixed frame (not shown) after being manufactured in a flat shape. That is, the display panel DP may have substantially the same shape as the cover window CW.

The display panel DP may include a flat portion PFP having a flat surface, side portions PSP each adjacent to an edge of the flat portion PFP and having an outwardly convex curved surface, and corner portions PCP each connecting adjacent side portions PSP and having an outwardly convex curved surface. For example, the number of side portions PSP may be four, and the number of corner portions PCP may be four. That is, four edge portions of the display panel DP may be bent. However, the configuration of embodiments of the present disclosure is not limited thereto. For example, each of the number of side portions PSP and the number of corner portions PCP may be two.

The display panel DP may include a plurality of pixels PX displaying an image. The plurality of pixels PX may be disposed on each of the flat portion PFP and the side portions PSP of the display panel DP.

The display panel DP may include a flexible substrate such as plastic. In addition, the display panel DP may display an image through a pixel circuit and a light emitting element disposed on the flexible substrate.

The cover window CW may be disposed on the display panel DP. The cover window CW may be disposed on the display panel DP to protect the display panel DP. The cover window CW may include a glass substrate or a polymer substrate. For example, the cover window CW may include a tempered glass substrate. In another embodiment, the cover window CW may include a flexible material, such as plastic.

The cover window CW may have a curved corner. In an embodiment, the cover window CW may include a flat portion FP having a flat surface, side portions SP each adjacent to an edge EP of the flat portion FP, and corner portions CRP each connecting the adjacent side portions SP. For example, the number of side portions SP may be four, and the number of corner portions CRP may be four. That is, four edges of the cover window CW may be bent. However, the configuration of embodiments of the present disclosure is not limited thereto. For example, the number of side portions SP may be two, and the number of corner portions CRP may be two.

Each of the side portions SP may be bent about a virtual bending axis BX extending parallel to the edge EP of the flat part FP. The bending axis BX may extend in a first direction DR1 or a second direction DR2. Accordingly, each of the side portions SP may have an outwardly convex curved surface.

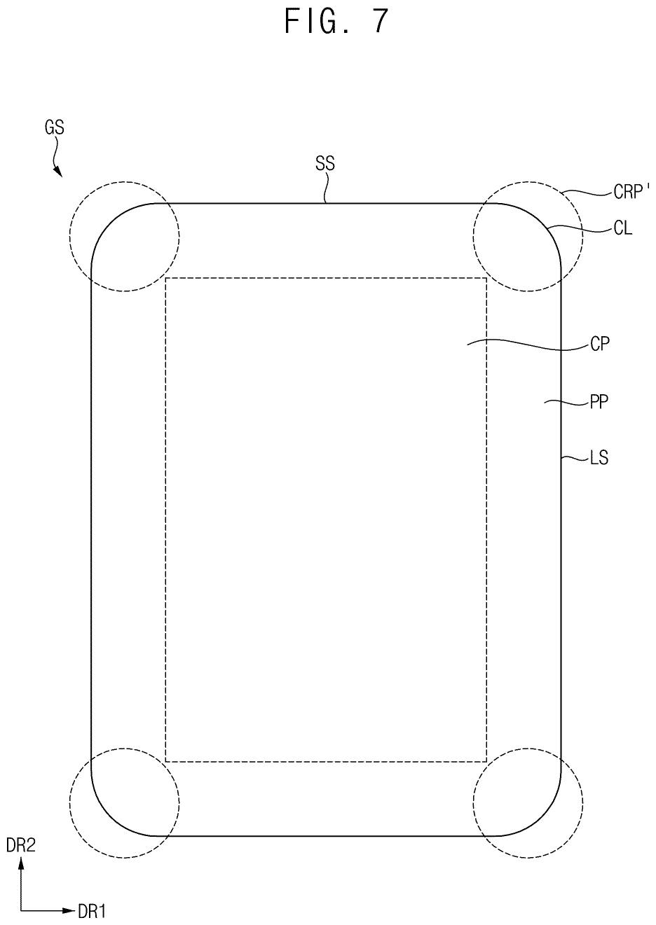

Each of the side portions SP may include a first side portion SP1 and a second side portion SP2. In an embodiment, the first side portion SP1 and the second side portion SP2 may have substantially the same radius of curvature. In an embodiment, an edge of a preliminary cover window (e.g., a glass substrate GS of FIG. 7) is bent with a curvature (e.g., a predetermined curvature) to form a flat portion and the first side portion SP1, and an edge of the flat portion is bent with a curvature (e.g., a predetermined curvature) to form the flat portion FP and the second side portion SP2 of the cover window CW.

Although the side portion SP is illustrated in FIG. 1 as including the first side portion SP1 and the second side portion SP2, embodiments of the present invention are not limited thereto. For example, the side portion SP may include at least three or more portions bent in the same direction. In another embodiment, the side portion SP may not be divided into two or more portions bent in the same direction.

Each of the corner portions CRP may be positioned adjacent to a vertex of the flat portion FP to connect two adjacent side portions SP. Each of the corner portions CRP may have an outwardly convex curved surface.

In an embodiment, a thickness T of the cover window CW may be substantially the same regardless of position. That is, the thickness T of the flat portion FP of the cover window CW, the thickness T of the corner portion CRP, and the thickness T of the side portion SP may be substantially the same. However, the present disclosure is not limited thereto, and the thickness T of the cover window CW may be different depending on the position.

In an embodiment, a radius of curvature R of an inner surface IS of each of the side portions SP may be equal to the radius of curvature R of the inner surface IS of each of the corner portions CRP. In another embodiment, the radius of curvature R of the inner surface IS of each of the side portions SP may be different from the radius of curvature R of the inner surface of each of the corner portions CRP. Herein, an embodiment in which the radius of curvature R of the inner surface IS of each of the side portions SP and the radius of curvature R of the inner surface IS of each of the corner portions CRP are the same will be described.

In an embodiment, the radius of curvature R of the inner surface IS of each of the corner portions CRP may be about 2.5 mm to about 3.5 mm. For example, the radius of curvature R of the inner surface IS of each of the corner portions CRP may be about 3.5 mm. However, the present disclosure is not limited thereto.

In an embodiment, when the thickness T of the cover window CW is about 0.5 mm, a height H from an outer surface OS of the cover window CW to a virtual plane formed by lower surfaces of the corner portions CRP may be about 3.85 mm to about 4.15 mm. For example, the height H from the outer surface OS of the flat portion FP of the cover window CW to the virtual plane formed by the lower surfaces of the corner portions CRP may be defined as the sum of the thickness T of the cover window CW and the radius of curvature R of the inner surface IS of the corner portion CRP of the cover window CW. Here, the virtual plane may be defined as a plane formed by the first direction DR1 and the second direction DR2 crossing the first direction DR1.

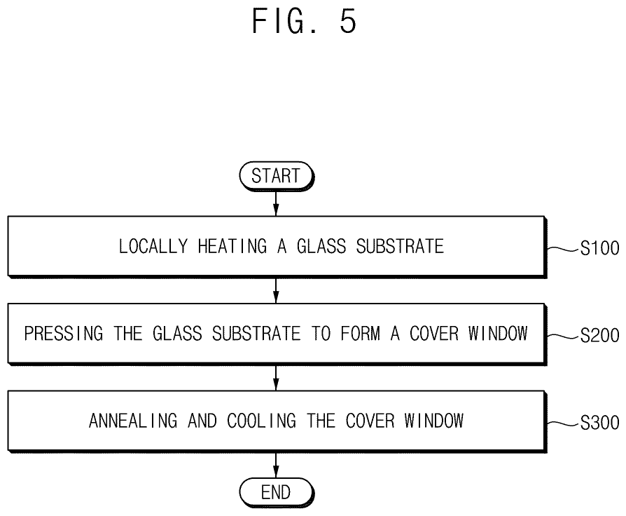

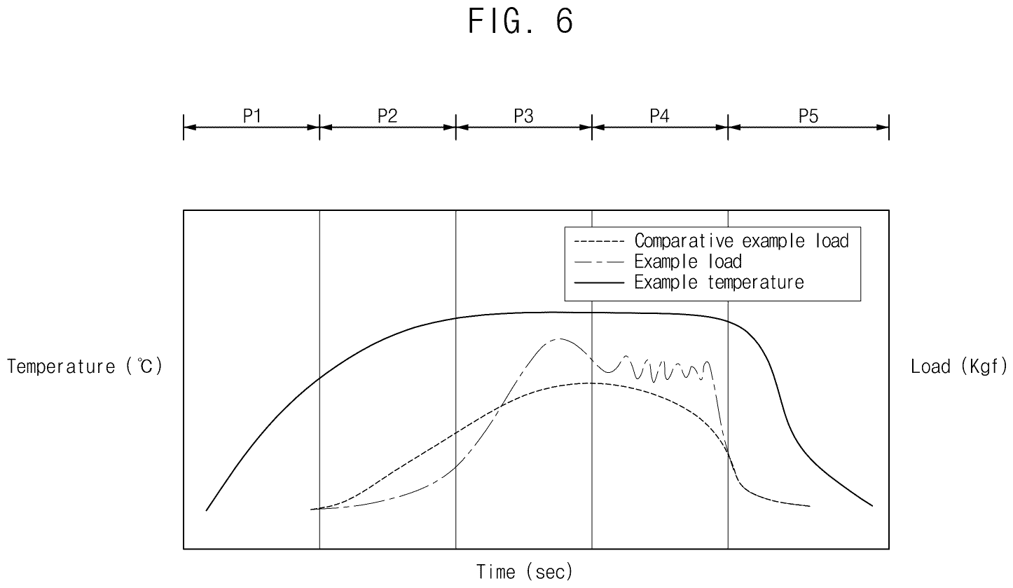

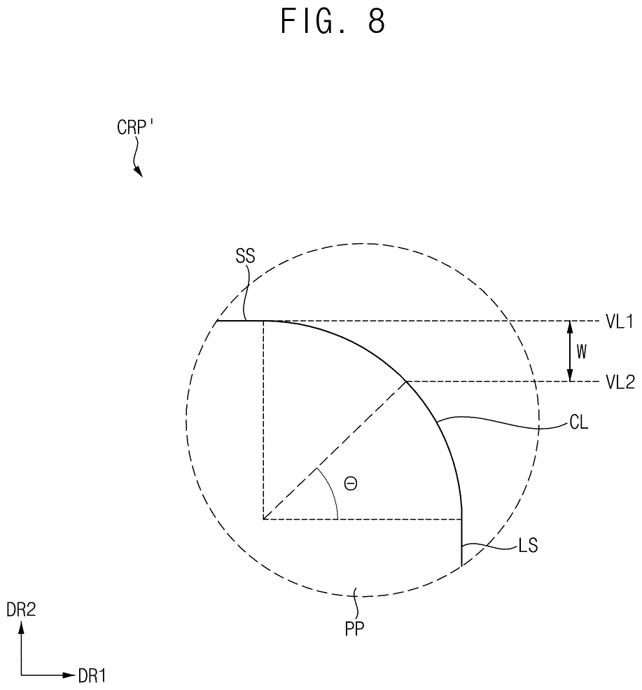

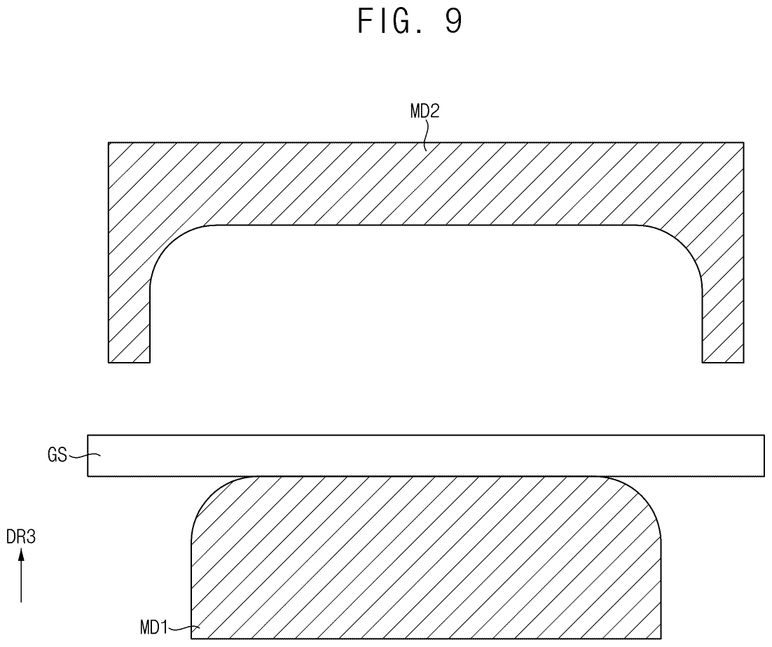

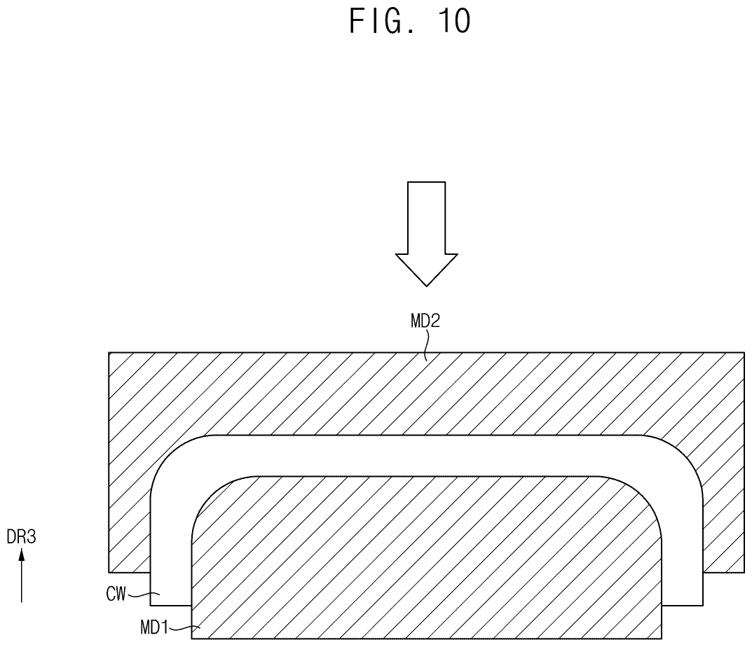

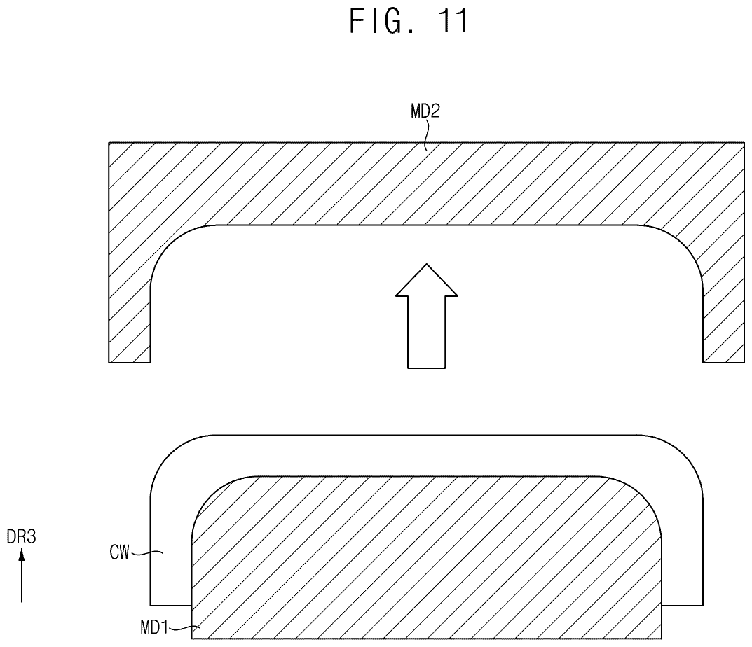

FIG. 5 is a flowchart illustrating a molding method for a cover window according to an embodiment; FIG. 6 is a view for explaining the molding method for the cover window of FIG. 5; FIG. 7 is a plan view illustrating a glass substrate; FIG. 8 is an enlarged plan view of a region of FIG. 7; and FIGS. 9, 10, and 11 are cross-sectional views for explaining some steps of the molding method for the cover window of FIG. 5.

Referring to FIGS. 1 and 5 to 11, a molding method for a cover window according to an embodiment of the present invention may include locally heating the glass substrate GS (S100), forming the cover window CW by pressing the glass substrate GS (S200), and annealing and cooling the cover window CW (S300). Herein, each step will be described in further detail.

First, the glass substrate GS serving as a material of the cover window CW may be provided. That is, the glass substrate GS refers to the cover window CW in a state before molding, and may include the same material as the cover window CW.

The glass substrate GS may include a central portion CP and a peripheral portion PP. The peripheral portion PP of the glass substrate GS may be adjacent to edges of the central portion CP. In an embodiment, the peripheral portion PP of the glass substrate GS may be around (e.g., surround) the central portion CP of the glass substrate GS. The central portion CP of the glass substrate GS may be formed as the flat portion FP of the cover window CW through the molding method of the cover window, and the peripheral portion PP of the glass substrate GS may be formed as the side portion SP and the corner portion CRP of the cover window CW through the molding method of the cover window.

In an embodiment, a planar shape of the peripheral portion PP of the glass substrate GS may include a short side SS extending in the first direction DR1, a long side LS extending in the second direction DR2 orthogonal to the first direction DR1, and a curve CL connecting an end of the shot side SS and an end of the long side LS. In an embodiment, the peripheral portion PP of the glass substrate GS may include a corner portion CRP′ adjacent to a vertex of the central portion CP, and the corner portion CRP′ may have the curve CL. For example, the number of each of the short side SS, the long side LS, and the curved line CL of the glass substrate GS may be four. However, embodiments of the present disclosure are not limited thereto, and the number of each of the short side SS, the long side LS, and the curve CL of the glass substrate GS may be varied.

In an embodiment, a width W in the second direction DR2 between a virtual first line VL1 extending from the end of the short side SS in the first direction DR1 and a virtual second line VL2 extending from a center of the curve CL in the first direction DR1 may be about 0.5 to about 0.6 of the radius of curvature R of the inner surface of the corner portion CRP of the cover window CW. In an embodiment, an angle θ between a first line connecting the center of the arc including the curve CL and the center of the curve CL and a second line extending from the center of the arc in the first direction DR1 may be about 45 degrees.

When the above conditions are satisfied, the cover window CW having the height H of about 3.85 mm to about 4.15 mm illustrated in FIGS. 1, 2, 3, and 4 may be formed through the glass substrate GS.

Referring to FIG. 6, the glass substrate GS may be locally heated in a first period P1. In an embodiment, the peripheral portion PP of the glass substrate GS may be locally heated. That is, the peripheral portion PP of the glass substrate GS may be locally heated, and the central portion CP of the glass substrate GS may not be heated. In this case, heat applied to the central portion CP of the glass substrate GS may be relatively small. Accordingly, thermal damage applied to the central portion CP of the glass substrate GS may be minimized or reduced.

In an embodiment, the peripheral portion PP of the glass substrate GS may be locally heated using an induction coil. However, embodiments of the present disclosure are not limited thereto, and the peripheral portion PP of the glass substrate GS may be locally heated through another method.

In an embodiment, the peripheral portion PP of the glass substrate GS may be heated to a temperature of about 610° C. to about 670° C. When the peripheral portion PP of the glass substrate GS is heated to a temperature lower than about 610° C. or higher than about 670° C., a clean area rate (“CAR”) of the cover window CW is reduced or a wrinkle length of the cover window CW may be increased.

Here, the clean area ratio may mean a ratio of the length of a portion where transfer molding occurs and the length of a portion where transfer molding does not occur among the total lengths of diagonal lines. The diagonal lines may be defined as connecting facing vertices of the flat portion FP of the cover window CW.

In addition, the wrinkle length may refer to an average value obtained by measuring the wrinkle length of the corner portion CRP of the cover window CW under reflected light.

The glass substrate GS may be pressed in a second period P2, a third period P3, and a fourth period P4. In an embodiment, a load applied to the glass substrate GS may gradually increase in the second period P2 and the third period P3, and the load applied to the glass substrate GS may be constant in the fourth period P4. For example, a rate at which the load applied to the glass substrate GS increases in the third period P3 may be different from a rate at which the load applied to the glass substrate GS increases in the second period P2. In an embodiment, the rate at which the load applied to the glass substrate GS increases in the third period P3 may be greater than the rate at which the load applied to the glass substrate GS increases in the second period P2. That is, the rate at which the load applied to the glass substrate GS increases in the second period P2 may be smaller than a rate of a comparative example in the second period P2, and the rate at which the load applied to the glass substrate GS increases in the third period P3 may be greater than a rate of the comparative example in the third period P3.

Referring briefly to the pressing the glass substrate GS with reference to FIGS. 9, 10, and 11, the glass substrate GS may be placed on a first mold MD1 to press the glass substrate GS. Then, the glass substrate GS may be pressed by a second mold MD2. As the second mold MD2 presses the glass substrate GS, an edge of the glass substrate GS may be bent along a shape of the first mold MD1. In an embodiment, the first mold MD1 may have a rectangular cross-sectional shape with rounded corners. In addition, the second mold MD2 may have a cross-sectional shape that engages with the first mold MD1.

Accordingly, a cover window CW having the same shape as the cover window CW illustrated in FIGS. 1, 2, 3, and 4 may be formed. After forming the cover window CW by pressing the glass substrate GS with the second mold MD2, the second mold MD2 may be moved away from the first mold MD1.

In an embodiment, the locally heating the glass substrate GS (S100) may be performed at least partially concurrently (e.g., simultaneously) with the pressing the glass substrate GS (S200). For example, the peripheral portion PP of the glass substrate GS may be locally heated in the first, second, third, and fourth periods P1, P2, P3, and P4, and the glass substrate GS may be pressed in the second, third, and fourth periods P2, P3, and P4. That is, the locally heating the glass substrate GS (S100) may be performed concurrently (e.g., simultaneously) with the pressing the glass substrate GS (S200) in the second, third, and fourth periods P2, P3, and P4.

In a fifth period P5, the cover window CW formed by pressing the glass substrate GS may be annealed and cooled. Accordingly, the cover window CW illustrated in FIGS. 1, 2, 3, and 4 may be formed through the glass substrate GS.

The molding method for the cover window according to embodiments of the present disclosure may include locally heating the peripheral portion PP of the glass substrate GS around (e.g., surrounding) the central portion CP of the glass substrate GS, forming the cover window CW by pressing the glass substrate GS, and annealing and cooling the cover window CW. Here, the pressing the glass substrate GS may include a first pressing step in which a load applied to the glass substrate GS gradually increases, a second pressing step in which a rate at which a load applied to the glass substrate GS increases is greater than a rate at which a load applied to the glass substrate GS increases in the first pressing step, and a third pressing step in which a load applied to the glass substrate GS is constant. Accordingly, the cover window CW in which each of edges has an outwardly convex curved surface through the glass substrate GS may be formed. In addition, the surface roughness of the cover window CW formed through the glass substrate GS may be improved.

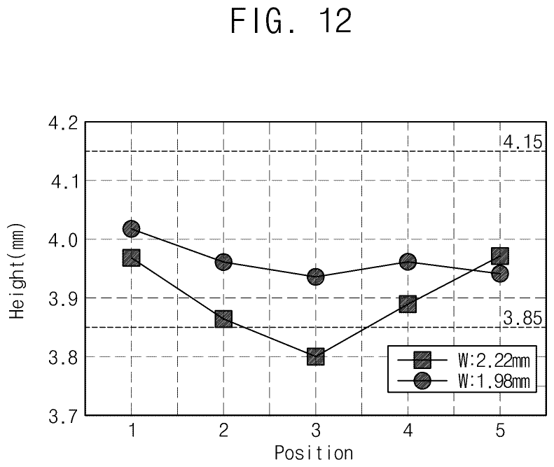

FIG. 12 is a view illustrating a height of the cover window according to a position of the cover window of FIG. 1.

Referring to FIGS. 1, 7, 8, and 12, the height H of the cover window CW manufactured according to a comparative example and an example was measured according to the position of the cover window CW.

First, in the glass substrate GS satisfying the comparative example, the width W in the second direction DR2 between the virtual first line VL1 extending from the end of the glass substrate GS in the first direction DR1 and the virtual second line VL2 extending from the center of the curve CL in the first direction DR1 was about 2.22 mm. On the other hand, in the glass substrate GS satisfying the example, the width W in the second direction DR2 between the virtual first line VL1 extending from the end of the glass substrate GS in the first direction DR1 and the virtual second line VL2 extending from the center of the curve CL in the first direction DR1 was about 1.98 mm. A cover window was manufactured using the glass substrate GS satisfying the comparative example and the example through the molding method for the cover window illustrated in FIGS. 5 and 6.

As a result, in the glass substrate GS satisfying the comparative example, the width W in the second direction DR2 between the virtual first line VL1 extending from the end of the short side SS in the first direction DR1 and the virtual second line VL2 extending from a center of the curve CL in the first direction DR1 was measured as about 0.63 of the radius of curvature R of the inner surface of the corner portion CRP of the cover window CW. In this case, in the cover window CW manufactured through the glass substrate GS satisfying the comparative example, that the height H from the outer surface OS of the cover window CW to the virtual plane formed by the lower surfaces of the corner portions CRP of the cover window CW is less than about 3.85 mm may be confirmed in a third position (i.e., a third position 3 in FIG. 2) of the cover window CW.

On the other hand, in the glass substrate GS satisfying the example, the width W in the second direction DR2 between the virtual first line VL1 extending from the end of the short side SS in the first direction DR1 and the virtual second line VL2 extending from a center of the curve CL in the first direction DR1 was measured as about 0.56 of the radius of curvature R of the inner surface of the corner portion CRP of the cover window CW. In this case, in the cover window CW manufactured through the glass substrate GS satisfying the example, that the height H from the outer surface OS of the cover window CW to the virtual plane formed by the lower surfaces of the corner portions CRP of the cover window CW is less than about 3.85 mm to about 4.15 mm may be confirmed in first, second, third, fourth, and fifth positions (i.e., first, second, third, fourth, and fifth positions 1, 2, 3, 4, and 5 in FIG. 2) of the cover window CW.

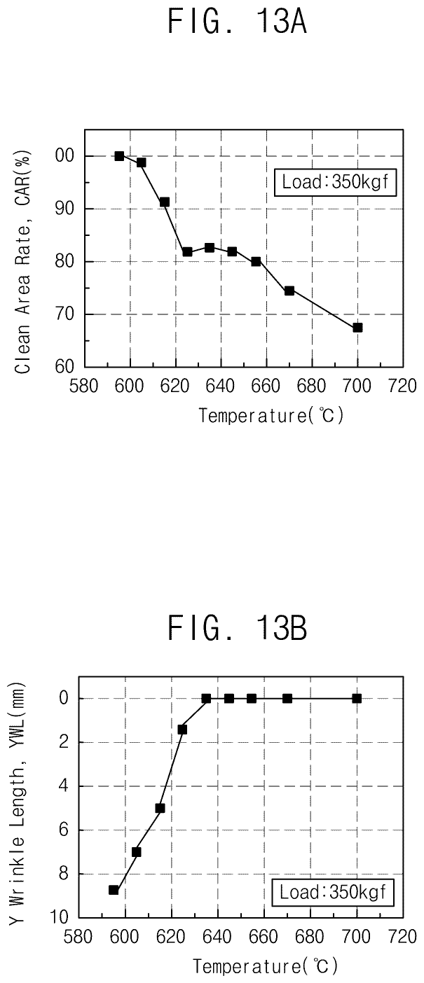

FIGS. 13A and 13B are views respectively illustrating a clean area ratio and a wrinkle length of the cover window according to temperature in the step of heating the glass substrate of FIG. 5.

Referring to FIGS. 5, 6, 13A, and 13B, Corning's Gorilla Victus™ was used as the glass substrate GS. The deterioration point of the Gorilla Victus™ is about 827° C.

Then, in the pressing of the glass substrate GS, with the maximum value of the load applied to the glass substrate GS being about 350 kgf, the clean area ratio (see FIG. 13A) and the wrinkle length (see FIG. 13B) of the cover window CW manufactured through the glass substrate GS according to the temperature of the heat applied to the glass substrate GS were measured.

As a result, when the glass substrate GS is heated to a temperature of about 640° C., that the wrinkle length of the corner portion CRP of the cover window CW is about 0, and the clean area ratio of the cover window CW is about 80% may be confirmed.

Accordingly, when the load applied to the glass substrate GS is about 350 kgf, that the cover window CW having the optimum condition can be manufactured only when the temperature of the heat applied to the glass substrate GS is about 640° C. may be confirmed.

Through this, when the load applied to the glass substrate GS is about 350 kgf, the optimum condition for the temperature of the heat applied to the glass substrate GS is about 640° C., and that the temperature of the heat applied to the glass substrate GS satisfies the range of about 610° C. to about 670° C. may be confirmed.

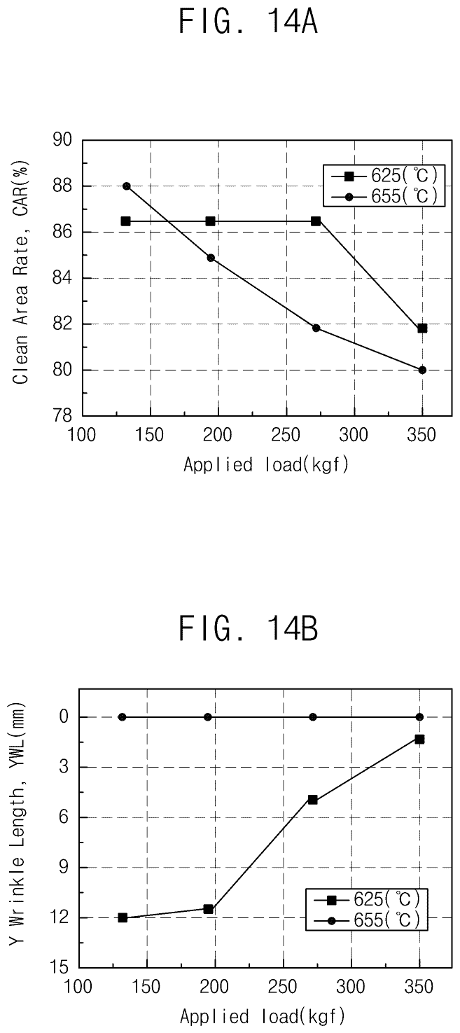

FIGS. 14A and 14B are views respectively illustrating a clean area ratio and a wrinkle length of the cover window according to a load in the step of pressing the cover window of FIG. 5.

Referring to FIGS. 5, 6, 14A, and 14B, Corning's Gorilla Victus™ was used as the glass substrate GS. The deterioration point of the Gorilla Victus™ is about 827° C.

Then, in the locally heating the glass substrate GS, the temperature of the heat applied to the glass substrate GS was set to about 620° C. in a first example and the temperature of the heat applied to the glass substrate GS was set to about 655° C. in a second example. In the first example and the second example, the clean area ratio (see FIG. 14A) and the wrinkle length (see FIG. 14B) of the cover window CW manufactured through the glass substrate GS according to the load applied to the glass substrate GS were measured.

As a result, in the first example, when the load applied to the glass substrate GS is about 300 kgf, the wrinkle length of the corner portion CRP of the cover window CW is about 5 mm, and the clean area ratio of the cover window CW is about 85% may be confirmed.

In addition, in the second example, when the load applied to the glass substrate GS is about 300 kgf, the wrinkle length of the corner portion CRP of the cover window CW is about 0 mm, and the clean area ratio of the window CW is about 81% may be confirmed.

Accordingly, when the temperature of the heat applied to the glass substrate GS is about 620° C. or about 655° C., that the cover window CW having the optimal condition can be manufactured only when the load applied to the glass substrate GS is about 300 kgf may be confirmed.

Through this, when the temperature of the heat applied to the glass substrate GS is about 620° C. or about 655° C., that the optimal condition for the load applied to the glass substrate GS is about 300 kgf, and the load applied to the glass substrate GS satisfies the range of about 200 kgf to about 350 kgf may be confirmed.

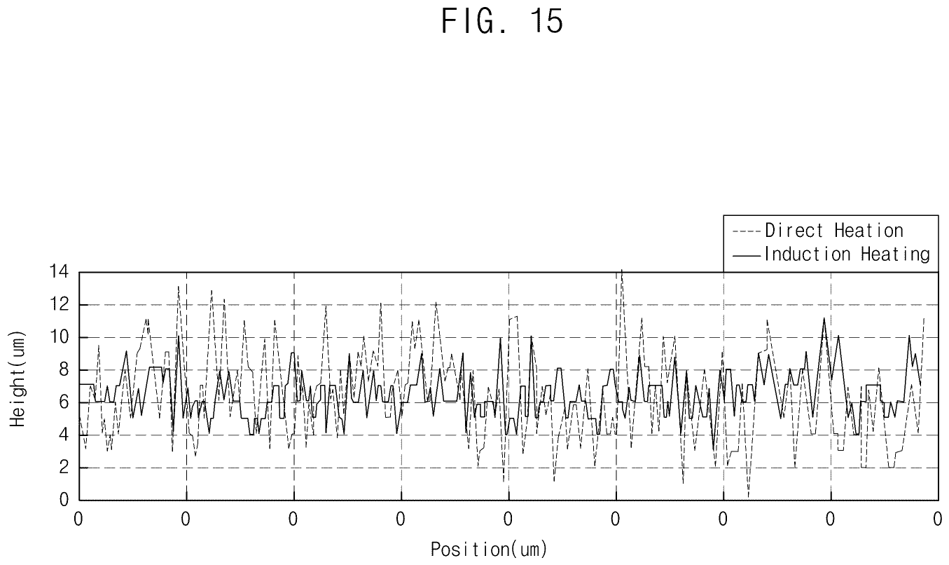

FIG. 15 is a view for explaining surface roughness of a cover window according to a comparative example and an example.

Referring to FIGS. 1, 2, 3, 4, 7, 8, and 15, a horizontal axis of the table illustrated in FIG. 15 means positions directed in a diagonal direction between the first direction DR1 and the second direction DR2 at ends of the corner portion CRP of the cover window CW and a vertical axis of the table means a peak value and a valley value measured with respect to the reference plane of the cover window CW.

In the comparative example, the cover window CW was manufactured by directly heating the central portion CP and the peripheral portion PP of the glass substrate GS. On the other hand, in the example, the cover window CW was manufactured by locally heating the peripheral portion PP of the glass substrate GS. According to the comparative example and the example, a difference between a maximum peak value and a maximum valley value of the cover window CW according to the position of the cover window CW was measured.

As a result, in the comparative example, that the difference between the maximum peak value and the maximum valley value of the cover window CW is about 14 μm may be confirmed. On the other hand, in the example, that the difference between the maximum peak value and the maximum valley value of the cover window CW is about 8 μm may be confirmed.

Through this, that the surface roughness of the cover window CW satisfying the example is improved compared to the surface roughness of the cover window CW satisfying the comparative example may be confirmed.

Embodiments of the present disclosure may be applied to various display devices. For example, embodiments of the present disclosure are applicable to various display devices, such as display devices for vehicles, ships and aircraft, portable communication devices, display devices for exhibition or information transmission, medical display devices, and the like.

The foregoing is illustrative of one or more embodiments of the present disclosure but is not to be construed as limiting thereof. Although some embodiments have been described, those skilled in the art will readily appreciate that many modifications are possible in the embodiments without materially departing from the teachings and aspects of the present inventive concept. Accordingly, all such modifications are intended to be included within the scope of the present inventive concept as set forth in the claims. Therefore, it is to be understood that the foregoing is illustrative of various embodiments and is not to be construed as limited to the specific embodiments disclosed, and that modifications to the disclosed embodiments, as well as other embodiments, are intended to be included within the scope of the appended claims.

What is claimed is:

1. A molding method for a cover window, the molding method comprising:
locally heating a peripheral portion of a glass substrate around a central portion of the glass substrate to a temperature of about 610° C. to about 670° C.;
forming a cover window by pressing the glass substrate; and
annealing and cooling the cover window.

2. The molding method of claim 1, wherein, in the locally heating the glass substrate, an induction coil is used.

3. The molding method of claim 1, wherein the forming the cover window comprises:
a first pressing step in which a load applied to the glass substrate gradually increases;
a second pressing step in which a load applied to the glass substrate gradually increases; and
a third pressing step in which a load applied to the glass substrate is constant.

4. The molding method of claim 3, wherein a rate at which the load applied to the glass substrate increases in the second pressing step is different from a rate at which the load applied to the glass substrate increases in the first pressing step.

5. The molding method of claim 3, wherein a rate at which the load applied to the glass substrate increases in the second pressing step is greater than a rate at which the load applied to the glass substrate increases in the first pressing step.

6. The molding method of claim 1, wherein the locally heating the glass substrate is performed at least partially concurrently with the pressing the glass substrate.

7. The molding method of claim 1, wherein the cover window comprises:
a flat portion corresponding to the central portion;
side portions each adjacent to an edge of the flat portion and comprising an outwardly convex curved surface; and
corner portions each connecting two adjacent side portions among the side portions and comprising an outwardly convex curved surface.

8. The molding method of claim 7, wherein a height from an outer surface of the cover window to a virtual plane formed by lower surfaces of the corner portions is about 3.85 mm to about 4.15 mm.

9. The molding method of claim 7, wherein a radius of curvature of an inner surface of each of the side portions of the cover window is equal to a radius of curvature of an inner surface of each of the corner portions of the cover window.

10. The molding method of claim 9, wherein a planar shape of the peripheral portion of the glass substrate comprises a short side extending in a first direction, a long side extending in a second direction orthogonal to the first direction, and a curve connecting an end of the short side and an end of the long side, and
wherein a width in the second direction between a virtual first line extending from the end of the short side in the first direction and a virtual second line extending from a center of the curve in the first direction is about 0.5 to about 0.6 of the radius of curvature of the inner surface of each of the corner portions of the cover window.

11. A molding method for a cover window, the molding method comprising:
locally heating a peripheral portion of a glass substrate around a central portion of the glass substrate;
forming a cover window by pressing the glass substrate with a load of about 200 kgf to about 350 kgf; and
annealing and cooling the cover window.

12. The molding method of claim 11, wherein, in the locally heating the glass substrate, an induction coil is used.

13. The molding method of claim 11, wherein the forming the cover window comprises:
a first pressing step in which a load applied to the glass substrate gradually increases;
a second pressing step in which a load applied to the glass substrate gradually increases; and
a third pressing step in which a load applied to the glass substrate is constant.

14. The molding method of claim 13, wherein a rate at which the load applied to the glass substrate increases in the second pressing step is different from a rate at which the load applied to the glass substrate increases in the first pressing step.

15. The molding method of claim 13, wherein a rate at which the load applied to the glass substrate increases in the second pressing step is greater than a rate at which the load applied to the glass substrate increases in the first pressing step.

16. The molding method of claim 11, wherein the locally heating the glass substrate is performed at least partially concurrently with the pressing the glass substrate.

17. The molding method of claim 11, wherein the cover window comprises:
a flat portion corresponding to the central portion;
side portions each adjacent to an edge of the flat portion and comprising an outwardly convex curved surface; and
corner portions each connecting two adjacent side portions among the side portions and comprising an outwardly convex curved surface.

18. The molding method of claim 17, wherein a height from an outer surface of the cover window to a virtual plane formed by lower surfaces of the corner portions is about 3.85 mm to about 4.15 mm.

19. The molding method of claim 17, wherein a radius of curvature of an inner surface of each of the side portions of the cover window is equal to a radius of curvature of an inner surface of each of the corner portions of the cover window.

20. The molding method of claim 19, wherein a planar shape of the peripheral portion of the glass substrate comprises a short side extending in a first direction, a long side extending in a second direction orthogonal to the first direction, and a curve connecting an end of the short side and an end of the long side, and
wherein a width in the second direction between a virtual first line extending from the end of the short side in the first direction and a virtual second line extending from a center of the curve in the first direction is about 0.5 to about 0.6 of the radius of curvature of the inner surface of each of the corner portions of the cover window.
